(19) United States
(12) Patent Application Publication
(10) Pub. No.: US 2006/0004501 A1
(43) Pub. Date: Jan. 5, 2006

(54) Method of operating an engine cooling permanent magnet DC motor to increase motor life

(76) Inventors: Martin Volkening, London (CA); Attila Simofi-Ilyes, London (CA)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/174,025

(22) Filed: Jul. 1, 2005

Related U.S. Application Data
(60) Provisional application No. 60/585,335, filed on Jul. 2, 2004.

(51) Int. Cl. G06F 17/00

(52) U.S. Cl. 701/36; 701/1

(57) ABSTRACT

A method is provided for cleaning a DC permanent magnet motor 15 of a vehicle. The motor 15 has a commutator 16 and brushes 18 and is capable of operating at, at least a low speed and a high speed. The method obtains certain operating data associated with the vehicle. The certain operating data is compared to a threshold. If the certain operating data is greater than the threshold, it is determined if a speed of the vehicle is greater than a certain value. If the speed of the vehicle is greater than the certain value, the motor 15 is operated at high speed for a certain amount of time.

This application claims the benefit of U.S. Provisional Application No. 60/585,335, filed on Jul. 2, 2004, which is hereby incorporated by reference in its entirety.

### BACKGROUND OF THE INVENTION

When a motor for an engine cooling fan/motor assembly is ventilated (e.g., has ventilation holes in a housing thereof), contaminants such as mud, salt, etc., can enter the motor and contact the commutator interface surface and/or enter the brush tube and hamper the operation of brush springs and the brushes. The contaminants may not be removed when the motor is operated at low and medium speeds, which can reduce the life of the motor. In addition, extended amount of running at low or medium speed tends to wear the brushes in an undesirable way and does not create the much needed filming on the commutator.

Commutator film is developed by a chemical reaction between the copper surface of the commutator and the surface of the brush, together with the surrounding air. This film is required to have a good commutation and to have acceptable noise emissions from the motor. In vehicle conditions where a motor operates in a mixture of heat, water, mud, salt and vibration, the actual brush wear rates are much different from conditions under which lab testing can be performed.

Thus, there is a need to provide an algorithm in a vehicle Engine Control Unit (ECU) that turns on an engine cooling motor to high or full speed for a period of time in order to clean the commutator and to lay down a new film, and to shake loose any contaminants that may hinder operation of the brushes.

### SUMMARY OF THE INVENTION

An object of the invention is to fulfill the need referred to above. In accordance with the principles of the present invention, this objective is achieved by providing method for cleaning a DC permanent magnet motor of a vehicle. The motor has a commutator and brushes and is capable of operating at, at least a low speed and a high speed. The method obtains certain operating data associated with the vehicle. The certain operating data is compared to a threshold. If the certain operating data is greater than the threshold, it is determined if a speed of the vehicle is greater than a certain value. If the speed of the vehicle is greater than the certain value, the motor is operated at high speed for a certain amount of time.

In accordance with another aspect of the invention, a computer readable medium has stored thereon sequences of instructions for cleaning a DC permanent magnet motor of a vehicle based on obtaining certain operating data associated with the vehicle. The motor has a commutator and brushes and is capable of operating at, at least a low speed and a high speed. The sequence of instructions include instructions for comparing the certain operating data to a threshold, if the certain operating data is greater than the threshold, determining if a speed of the vehicle is greater than a certain value, and if the speed of the vehicle is greater than the certain value, operating the motor at high speed for a certain amount of time.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, in which:

FIG. 1 is a schematic view of a vehicle's electronic control unit (ECU) shown for controlling a permanent magnet brush-type DC motor assembly in accordance with the principles of the present invention.

FIG. 2 is flow chart of a process of an embodiment of the invention.

### DETAILED DESCRIPTION OF THE EXEMPLARY EMBODIMENT

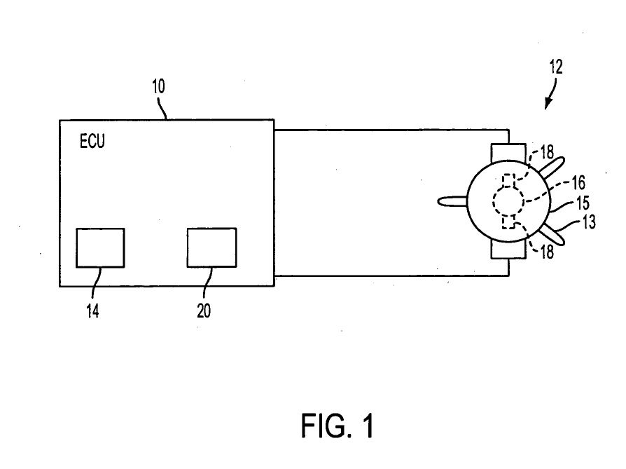

With reference to FIG. 1, a vehicle's electronic control unit (ECU) 10 shown for controlling a DC fan/motor assembly, generally indicated at 12, in accordance with the principles of the present invention. The fan/motor assembly 12 includes at least one fan 13 at least one motor 15 to operate the fan 13. The motor 15 is preferably a ventilated permanent magnet, engine cooling motor for a vehicle having a commutator 16 and at least two brushes 18. The motor 15 is capable of operating at, at least a low speed and a high speed.

In accordance an embodiment, an algorithm in the ECU 10 includes the following run pattern and dependencies:

A device 14 such as a timer, counter or distance switch is implemented in the ECU 10 to determine if or when there is some usage of the fan/motor assembly 12. The device 14 is shown to be part of the ECU 10, but it can be appreciated that the device 14 can be separate from the ECU but operatively associated therewith to provide certain vehicle operating data to the ECU 10. For example, as soon as the usage exceeds the determined usage for the specific vehicle, the ECU 10 turns on the fan/motor assembly 12 to high or full speed for a certain amount of time in order to clean the commutator 16 and brushes 18 and to lay down a new film. With regard to the fan/motor assembly 12 operating noise, the noise is masked with normal driving noise. Therefore, the full speed operation of the fan/motor assembly 12 for cleaning thereof is preferably limited to when the speed of the vehicle is greater than a threshold, for example, at least 60 km/h. Thus, the driver cannot detect the cleaning operation of the fan/motor assembly 12.

This cleaning mode of the fan/motor assembly 12 can be triggered by one of three basic types of comparisons while the vehicle's engine is on:
A) If a timer is implemented, after a certain amount of engine run time (e.g., threshold of at least 100 hrs), the fan/motor assembly 12 is turned on by the ECU 10 in order to clean the commutator 16 and brushes 18.
B) If a counter is implemented, after a number (e.g., threshold of at least 30) of startups of the fan/motor assembly 12 at low speed without running at high speed, the fan/motor assembly 12 is turned on to high speed by the ECU in order to clean the commutator and brushes.
C) The cleaning mode could also be triggered by exceeding a pre-determined distance the vehicle is driven (e.g., threshold of a minimum of 5000 km).

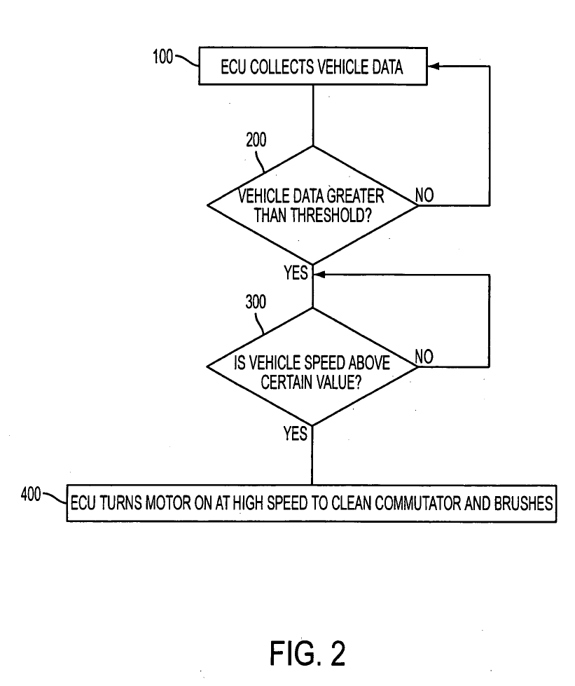

FIG. 2 shows a flow chart of an embodiment of a process of cleaning the fan/motor 12. In step 100, the ECU 10 collects certain vehicle data from device 14, such as kilometers the vehicle is driven, hours of vehicle operation, counting times when the fan/motor assembly 12 is on low speed without running at high speed, season of operation, and/or date the vehicle is driven.

In step 200, the ECU 10 compares the certain vehicle data obtained in step 100 to a threshold such as one of the thresholds noted above. If the certain vehicle data is greater than the threshold, the ECU 10 in step 300 determines if the vehicle speed (as measured by, for example, a speedometer) is above a minimum level such as 60 km/hr. If so, in step 400, the ECU 10 turns the fan/motor assembly 12 on at high speed for a certain amount of time (e.g., at least ten minutes). The operation of the fan/motor assembly 12 at high speed cleans the commutator 16 and brushes 18, lays down a new film, and thus adds to the life of the fan/motor assembly 12.

The steps described in of FIG. 2 can be implemented as executable code stored on computer readable medium (e.g., a hard disk drive, a floppy drive, a random access memory, a read only memory, an EPROM, a compact disc, etc.). It is preferable that a processor 20 of the ECU 10 executes the steps of FIG. 2. The ECU 10 can be considered to be a controller. The processor 20 can be separate from the ECU, for example, provided as part of the fan/motor assembly 12 internally or externally thereof. More particularly, the processor 20 can be incorporated into a conventional pulse width modulated (PWM) speed control unit.

Although an engine cooling fan/motor assembly 12 is disclosed, the method described herein is applicable to cleaning any commutated motor used in a vehicle.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A method of cleaning a DC permanent magnet motor of a vehicle, the motor having a commutator and brushes and being capable of operating at, at least a low speed and a high speed, the method including:
obtaining certain operating data associated with the vehicle,
comparing the certain operating data to a threshold,
if the certain operating data is greater than the threshold, determining if a speed of the vehicle is greater than a certain value, and
if the speed of the vehicle is greater than the certain value, operating the motor at high speed for a certain amount of time.

2. The method of claim 1, wherein the certain operating data is distance the vehicle was driven.

3. The method of claim 2, wherein the threshold is a distance driven of at least 5000 kilometers.

4. The method of claim 1, wherein the certain operating data is hours of operation of an engine of the vehicle.

5. The method of claim 4, wherein the threshold is at least 100 hours of operations of the engine of the vehicle.

6. The method of claim 1, wherein the certain operating data is a number of times the motor is operated only at low speed.

7. The method of claim 6, wherein the threshold is at least 30 times the motor is operated only at low speed.

8. The method of claim 1, wherein the certain value of vehicle speed is at least 60 km/hr.

9. The method of claim 1, wherein the motor is operated by a controller.

10. The method claim 1, wherein the certain amount of time is at least ten minutes.

11. A computer readable medium having stored thereon sequences of instructions for cleaning a DC permanent magnet motor of a vehicle based on obtaining certain operating data associated with the vehicle, the motor having a commutator and brushes and being capable of operating at, at least a low speed and a high speed, the sequence of instructions including instructions for performing the steps of:
comparing the certain operating data to a threshold,
if the certain operating data is greater than the threshold, determining if a speed of the vehicle is greater than a certain value, and
if the speed of the vehicle is greater than the certain value, operating the motor at high speed for a certain amount of time.

12. The media of claim 11, wherein the certain operating data is distance the vehicle was driven.

13. The media of claim 12, wherein the threshold is a distance driven of at least 5000 kilometers.

14. The media of claim 11, wherein the certain operating data is hours of operation of an engine of the vehicle.

15. The media of claim 14, wherein the threshold is at least 100 hours of operations of the engine of the vehicle.

16. The media of claim 11, wherein the certain operating data is a number of times the motor is operated only at low speed.

17. The media of claim 16, wherein the threshold is at least 30 times the motor is operated only at low speed.

18. The media of claim 11, wherein the certain value of vehicle speed is at least 60 km/hr.

19. The media of claim 11, in combination with a controller having a processor, the controller being constructed and arranged to control operation of the motor.

20. A controller for operating a DC permanent magnet motor of a vehicle to clean the motor, the motor having a commutator and brushes and being capable of operating at, at least a low speed and a high speed, the controller comprising:
means for obtaining certain operating data associated with the vehicle,
means for comparing the certain operating data to a threshold, and
if the certain operating data is greater than the threshold, means for determining if a speed of the vehicle is greater than a certain value,
wherein, if the speed of the vehicle is greater than the certain value, the controller being constructed and arranged to operate the motor at high speed for a certain amount of time.

21. The controller of claim 20, wherein the means for obtaining certain operating data is a timer that determines run time of an engine of the vehicle.

22. The controller of claim 20, wherein the means for obtaining certain operating data is a counter that counts a number of startups of the motor at low speed only.

23. The controller of claim 20, wherein the means for obtaining certain operating data is a device that measures distance traveled of the vehicle.
